(19) United States
(12) Patent Application Publication
(10) Pub. No.: US 2007/0137463 A1
(43) Pub. Date: Jun. 21, 2007

(54) Digital Music Composition Device, Composition Software and Method of Use

(76) Inventor: David John Lumsden, Port Ludlow, WA (US)

Correspondence Address: JACQUES M. DULIN, ESQ. DBA;INNOVATION LAW GROUP, LTD., 237 NORTH SEQUIM AVENUE, SEQUIM, WA, 98382-3456, US

(21) Appl. No.: 11/610,597

(22) Filed: Dec. 14, 2006

Related U.S. Application Data
(60) Provisional application No. 60/751,178, filed on Dec. 19, 2005.

(51) Int. Cl. G10H 7/00

(52) U.S. Cl. 84/603

(57) ABSTRACT

Personal Portable Groove Generator device (MP3/PDA/Cellphone form), software and website operation for truly novice Users to create unique musically complete compositions, automatically or User-generated, through menu-directed selection from loop libraries to mix and build novel, complete, rich, musical Grooves that can be audited, saved, up/down loaded, evolved, and shared, P2P or via a community or other website, on a free or subscription-type basis. In AUTOPLAY mode, the device automatically creates the composition by random selection of compatible loops once a STYLE has been selected by the User. In CREATE mode, the User builds a musical Groove by combining loop tracks. The User listens-to and selects successive categories of loops that are compatible in key, tempo and style, and each chosen loop is digitally combined with prior loop(s) to create the savable/sharable Groove. In addition to general popularity, the system has particular utility in the Music Therapy and Music Education fields.

### CROSS-REFERENCE TO RELATED APPLICATIONS

This application is a Regular U.S. Patent application of Provisional Patent Application Ser. No. 60/751,178 filed Dec. 19, 2005, entitled “GroovePod”, the benefit of the priority date of which is hereby claimed under 35 USC §120, 121, 365(c) or 119(e), as applicable.

### FIELD

The invention relates to a portable, personal electronic device that permits a truly novice, non-musically and non-technically trained User to compose music by means of an easy to navigate, menu-based software operating system, and thereafter to save and share the composition with others directly or indirectly, including via the Internet. The device has particular utility in the fields of Music Therapy and Music Education, but may also be configured as a popular consumer-type, stand alone, dedicated device having form factors like those of MP3 players. The composition functionality software can be loaded into the existing installed base of computers, laptops, Internet tablets, game consoles, cell phones, PDAs or MP3 players. The method of use includes a novel system that permits the User to navigate easily through a range of screen-displayed menus, and the establishment of User communities for uploading to and down-loading from a website, and for Peer-to-Peer (herein P2P) sharing of original compositions on a wide range of digital devices, including dedicated devices of this invention. The inventive system also includes establishment and management of a website for providing new groove menus and digital loops, on a free or subscription basis, and to facilitate communication and interaction among a community of Users.

### BACKGROUND

Current MP3 players, such as the Apple iPod, the Microsoft Zune, the San Disk Rhapsody, the Toshiba Gigabeat, the Creative Labs Zen Vision, Lexar MP3 player, and similar devices, are play-back-only or storage, playback and share-type devices. They do not have capability to compose or permit composition of digital music. The Zune includes provision for wireless sharing, directly to other Zune devices, of sample tracks, playlists, pictures, or “homemade” recordings.

Recently, cell phones have been configured to permit the creation of simple, mono-phonic ring tones (sequences of single notes), and to permit up and downloading for sharing.

There are a number of relatively complex digital music composition programs available for loading onto computers that permit composition of digital music, followed by saving them to memory and transfer to other devices or persons (sharing). Some devices, known as loop layers, allow Users to build up a musical composition gradually by combining musical “loops”. Such loops are musical samples, that is, small audio recordings of actual musical instruments, synthesized instruments, rhythm instruments, ambient (background) sounds called “pads”, and sound effects (herein SFX). Currently marketed Loop Players are available in two forms: dedicated hardware instruments or software for laptop or desktop/main frame computers. Most of these devices or programs are quite complex, and all require a creator/programmer to have at least some musical/music theory and technical/computer background, the more the better. All further require a significant level of manual dexterity and hand/eye coordination.

There are a number of patents and published applications directed to various features of music generation devices and programs, including: Najdenovski US2003/0076348; Yamaki et al U.S. Pat. No. 7,058,428; Lengling et al 2005/0145099; Herberger et al, US2006/0079213; Iwamoto et al, U.S. Pat. No. 6,835,884; Aoki et al, U.S. Pat. No. 6,472,591; Kurakake et al, U.S. Pat. No. 6,518,491; Sitrick, U.S. Pat. No. 5,728,960; and Roman et al, US2005/0259532. Of these, Najdenovski discloses a midi composer utilizing musical looping, Lengling discloses a method and apparatus for enabling advanced manipulation of audio, and Herberger discloses a system and method of music generation. These and the others are highly complex devices. Some of the devices involve use of a rotary wheel for navigation of menus: Rosin et al, U.S. Pat. Nos. 6,411,307 and 6,028,600; Cisar, U.S. Pat. No. 5,931,873. Designs of various portable players are shown by way of example in: Sitoh, D520515; Kataoka, D508834; and Andre et al, D497618.

It is clear from even a brief review of such patents and applications that the devices and methods shown in them are not amenable to use by non-technically trained persons for personal digital composition of music, much less for handicapped, disabled or elderly persons for music therapy purposes.

Accordingly there is a need in the art for a personal electronic device that permits a non-musically and non-technically trained User to compose aurally rich, extended music by means of an easy to navigate menu-based software operating system, and thereafter to save and share the composition with others directly or indirectly, including via the Internet, and for a system that does not require extensive learning of intricate computer composition programs or musical and composition theory, so that it can be used in popular, consumer-type stand alone MP3-type players, in cell phones or PDAs, and is amenable to use for handicapped, disabled, juvenile or elderly persons in the fields of Music Therapy and Music Education.

### The Invention

Summary, Including Objects and Advantages:

The invention comprises a portable consumer electronics device, operating and application software, and a community sharing system, for creation of complete, evolvable, musically rich, digital music compositions (herein also called “Grooves”). The inventive system comprises layering multiple tracks of loop elements provided in and retrieved from device memory to generate the Groove compositions, by truly novice, non-musically trained or talented, and non-technically trained or facile Users. The inventive system permits the User to generate, either automatically or by User-choice, a musical composition/Groove by combining (layering) loops, which are musical samples comprising small audio recordings, selected from among a menu of musical elements, such as: actual musical instruments, synthesized instruments or sounds, rhythm instruments or sounds, ambient (background) sounds (called “pads”) and sound effects (herein SFX).

The device User interface requires only rudimentary navigation (via joystick, rocker-type click-wheel, buttons, rotary click-wheel, toggle disk, stylus, touch pad, or other means) and selection on a simple LCD screen. In order to create a new, unique, constantly evolving musical composition, the User needs merely choose a musical style, then auditions “candidate” musical loop samples from a library or collection of stored loops from constituent musical elements or categories (e.g. Drums, Bass Lines, Melodies, Backing, SFX, etc.) When the User selects a musical loop sample for inclusion in the composition, the device then “offers” accompanying loops, all pre-selected for musical compatibility in terms of key, tempo, style and mood. While auditioning (listening to) a candidate loop, the User hears all parts of the composition-in-progress playing in unison with each candidate loop. Once the basic composition has been created, the composition device can “evolve” it, gradually substituting, or/and adding new musically compatible samples to produce a constantly changing but musically coherent extended musical experience. The User may save a given Groove composition “performance” (as metadata, not audio) for re-creation and replay at any time. This method of storing compositions, requiring only a few data bits per Groove, allows for maximum efficiency in use of available memory. Further, the created musical compositions may be audited, shared, edited, critiqueed and interpreted via wireless, a LAN (classroom or clinic, for instance) or WAN network, or via the Internet, e. g., by e-mail or website. Thus the device allows Users to create new, unique, evolving personal musical compositions on the go, without any previous musical or technical knowledge, and to store them for present or future listening, editing, sharing, or evolution.

The creation of Groove compositions is effected by the User through selection from a menu of sub-sets or collections of loops in memory to mix and build unique, fundamentally complete musical compositions that can be audited, saved, evolved, up/down loaded, shared, either P2P or via a community, or other type of website, on a free basis or subscription-type basis. The User selects and auditions (listens to) various samples, adds successive loops that are compatible in terms of key, tempo and style, each of which successive loop is digitally combined (digital equivalent of analog overdubbing or multi-track recording) with prior loop(s) until the final, desired, fully mixed Groove is achieved and saved by the User for replay or sharing.

In its device aspect the inventive system, as implemented in a portable dedicated device form factor, herein the Portable Groove Generator, abbreviated “PGG” (pronounced “Piji”), resembles an MP3 player or PDA, which includes a display screen, typically a color LCD with LED backlight or OEL (Organic Electro-Luminescent screen) on the order of 1″×3″ to about 3″×3″, a menu navigation, a rotary click-wheel or a disk-array of buttons. By way of example only, herein the device will be described with reference to a rotary click-wheel, called a Navwheel that can be both rotated to scroll amongst menu items displayed on screen and then depressed to select (or invoke) the chosen menu item. In an alternative, the Navwheel can also move laterally (angularly) to one or both sides (small transverse movement) as a functional way to retain a selection that is thereafter selected upon scrolling to a second menu choice. The device also includes: a power ON/OFF button; a volume controller, such as a slider, wheel or dial; and a stereo mini-jack for external earbud type headphones (preferably volume limited and noise cancelling), and, optionally, one or more jacks for power input or charging of onboard rechargeable batteries. The stereo mini-jack can also be used for output to one or more optional auxiliary speakers, either independent or in a dock. Optionally, the power/recharge jack can be a multi-pin jack for interfacing with a dock. The device preferably includes USB and/or Firewire ports for export/import to and from computers, cell phones, PDAs, laptops, Internet tablets, flash memory devices, and the like. The device also preferably includes a memory card slot for reading from or writing to a flash memory inserted in the slot, examples including SD and mini-SD cards. While the device form factor can be as large as a cell phone or MP3 player, one skilled in the electronic arts will recognize that these functionalities can be enabled in wrist-watch sized devices.

Internally, an exemplary embodiment of the inventive PGG device comprises: a CPU chip; a DAC chip to play musical loops in synch; both volatile and non-volatile memory, the latter containing data structures comprising a library (database) of collections of audio loops of different categories and saved compositions in tag or metadata form; software that includes functionality for: operation of the device; navigation software to facilitate auditioning and selecting sample loops and Grooves; application software for generation of the musical compositions, the presently preferred codec being MP3 file format; a text generator; image and video rendering functionality (mini video card); a random selection picker (random number generator); and optionally but preferably, a browser. The memory may be either active or static, that is hard drive or static memory (such as flash memory chip), or combinations of both.

The inventive software permits generation of the musical compositions by overlaying multiple loops that are either selected automatically, or selected by the User from among a menu of loop types. The software system renders the compositional mix process transparent to the User, and the PGG can be operated by anyone regardless of their musical or technical background and without the need for any training beyond a brief, intuitive and simple tutorial that is included and displayed or audibly presented to direct the User. The software enables this by permitting the User to simply navigate intuitively through successive menus and selecting, auditioning and saving musical samples presented as loops. It should be understood that the inventive Groove generation software can be provided as an add-on functionality to an MP3 player, such as: a cell phone; iPod, Zune, Lexar, Gigabeat, Zen Vision or Rhapsody players; radios (such as Sirius Stilletto, Samsung Nexus and Helix, Pioneer Inno, Delphi SKYFi3, and car radios with MP3 playback capability, and Internet Tablets, such as the Nokia 770, and the like.

The software supports audio, image (photo and graphics), video and internet radio playlist formats. Audio Loop digital files currently supported include: AAC (16-320 Kbps), protected AAC (Apple itunes), AMR, MP2, MP3 (16-320 Kbps), MP3-VBR, RA (Real Audio), WAV, WMA, Audible (2, 3 & 4), Apple Lossless and AIFF, and may include DRM coding. Image files currently supported include BMP, GIF, ICO, JPEG, PNG, TIFF, PSD (Mac only) and SVG-tiny. Video files currently supported include 3GP, AVI, H.263, MPEG-1, MPEG-4, and RV (Real Video). Internet radio playlists supported include M3U and PLS. As the industry changes and adopts additional or upgraded file formats, the device software new versions will include such formats. The device can also be configured to include wireless connectivity, such as WLAN 802.11b or g and Bluetooth 1.2 or higher. The USB/Firewire ports permit connectivity to PCs, PDAs and other devices for transfer of Loop Libraries and Grooves created by the User. Optionally, the device can include AM/FM or/and satellite radio tuners.

While the inventive system and method will have broad and deep appeal to the general consumer market, it is particularly useful in the field of Music Education (see Example 1) and in Music Therapy (see Example 2) as it is both inexpensive and amenable to use by young, handicapped, disabled and elderly persons. In addition to the specialized fields of Music Therapy and Music Education, the inventive system and method will also offer a unique benefit to the general consumer who, despite a lack of musical and technical training, wishes to experience the pleasure and satisfaction of involvement in creating a true musical composition, as opposed to merely listening to prerecorded music and for sharing on a community site (see Example 3).

In a first embodiment, the PGG device includes software providing functionality for automatically composing Grooves from a library of loop collections organized by individual categories stored in memory, which composition function is initiated by the User simply manipulating the Navwheel or stylus. The automatic Groove Composition software functionality, called A-Compose, for Automatic-Compose, may be the sole composition software in the device, or it may be associated with a second composition function in which the User makes a plurality of successive loop selections that are then combined as the resulting Groove composition. This second software functionality is called U-Compose, for User-Compose and may be loaded alone or in combination with A-Compose. That is either composition software modality may be used alone or in combination with the other mode, or additional, other software providing other functions for the particular device in which loaded.

In the A-Compose mode, the first step is for the User simply to turn “ON” the PGG device and plug in his/her ear-buds or speakers in the headphones/speaker jack. The User is immediately presented with the HOME screen. Here the User may, by rotating the Navwheel, choose from among the following menu items:

HOME

AUTOPLAY
PLAY
EVOLVE
SAVE
CREATE
DOWNLOAD
KARAOKE

1 ) AUTOPLAY, for the PGG device to create a new, complete composition automatically, in any style chosen by the User;

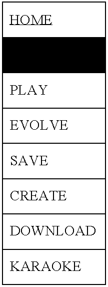

2) PLAY, to play a previously saved or downloaded Groove composition; or

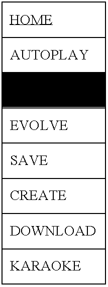

3) CREATE, to compose a new Groove composition piece from scratch, by the User choosing from among samples from the loop library element collections that are randomly chosen and automatically presented to the User by the PGG device;

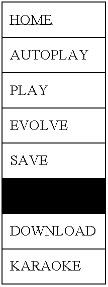

In either compose mode, after composing the User can: select SAVE to save to non-vola-tile, RAM memory one of the User's Groove compositions; DOWNLOAD to transfer the groove via the output port to another PGG, personal computer, or the Internet; or EVOLVE, to generate variations on the composition, described in more detail below.

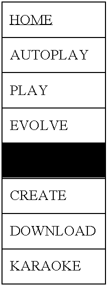

When either AUTOPLAY or CREATE is selected by depressing the Navwheel, the PGG automatically brings up the STYLES screen, from which the User selects the musical style that matches his/her mood, again by scrolling with the Navwheel to select a desired style. Note the heading “MORE”, which when selected can bring up any number of additional styles, such as: WORKOUT, ROMANTIC, LATIN, COUNTRY, MOODY, LOUNGE, HEAVY METAL, FUNK, PUNK, BLUES, ROCK'N ROLL, etc. It is clear that sub-folders can be included under each style for sub-styles, e.g., under style ETHNIC, can be POLKA, STAR, etc., and that as new styles arise, they can be provided by download or inclusion in memory chips inserted in the memory slot. Further, the STYLES menu and the Loops Libraries can be expanded and/or customized to include musical styles and instruments that conform to the needs and musical preferences of specific national, ethnic and/or cultural traditions. Thus, these mentioned are merely exemplary of hundreds of styles:

STYLE

ROCK
JAZZ
HIPHOP
TRANCE
BLUEGRASS
CLASSICAL
(MORE) . . .

Suppose the User selects JAZZ. Then, First as to the AUTOPLAY mode, the PGG device automatically plays a complete multi-track (multi-layered loop) composition composed randomly, in the style chosen by the User, here JAZZ, comprising one loop selected by the random picker function of the device from among the loops stored in each of the loop element sub-libraries: BASS, DRUMS, MELODY, BACKING, SFX, etc. The loops are selected out of the sub-libraries in RAM, mixed and transferred to volatile memory for playback. At the same time, the PGG device automatically returns the User to the HOME screen, where the User can select to SAVE the composition from volatile memory to non-volatile RAM, or EVOLVE. The multi-track Groove composition is, at a minimum, a 4-bar complete rich multi-track musical phrase or section which is compatible and “musically correct” in key, tempo and style. This randomly created 4-bar, complete, rich, multi-track Groove composition is repeated over and over as long as the User wants to listen. (EVOLVE is discussed below.) If the User does not like that composition, or has saved it and wants to hear another composition, the User toggles to AUTO-PLAY on the HOME screen and repeats the auto-compose process again.

Second, as to the CREATE mode, once a STYLE has been chosen, the PGG device automatically brings up the BASS screen, unless the User chose CLASSICAL as a style, in which case the composition process would begin on the MELODY screen with string melodies:

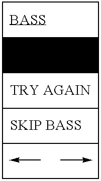

Continuing in the CREATE mode, as soon as the BASS screen comes up, the PGG device begins to play a randomly selected musical loop from the Bass Loop Sub-Library collection. The selection of this “Candidate Loop” is made by the random picker algorithm in the software selecting one loop from the collection of from about 10 to thousands of loops, here of JAZZ style BASS loops loaded into RAM memory. The Candidate Loop will be selected from the style already specified by the User, here JAZZ. While listening to the Candidate Loop, the User may elect to use that randomly selected loop in the Groove being composed by the User, by selecting →YES” via manipulation of the Navwheel (scrolling by rotating the Navwheel, followed by depressing the wheel). If the User does not like that Bass Loop, the User may select to try a different loop “TRY AGAIN”, or decide to not use bass at all by toggling “SKIP BASS”.

Once a candidate bass loop has been selected, the PGG device automatically brings up the DRUMS screen.

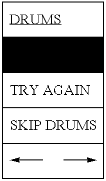

Note, the Bass loop continues to play, since clicking on YES in the BASS screen has preserved that auditioned bass loop in volatile memory during the rest of the composition process. This temporary saving process is called the Keep Function, which is distinct from SAVE. While the already-selected and therefore “Kept” BASS loop is playing, the User may successively audition candidate DRUM loops.

All candidate loops will be in the same key, tempo and style of the selected BASS loop and are played as mixed with the prior selected bass loop. That is, the loop is layered as a track with other loop tracks in proper synch with the prior ones. This feature is an important aspect of the inventive system, and is enabled by providing in the software an AUTOSYNC function, that permits the User to hear the developing stages of the composition at all times. This not only makes the composition process easy and fun, but also the User gains a sense of involvement and is exposed to two key aspects of musical education: the concept of mix and track layering of musical elements, and how the elements of music: melody, harmony, figured bass and rhythm, interact.

As with BASS, the selection options for DRUMS include TRY AGAIN and SKIP, in this case, DRUMS. TRY AGAIN is essentially an erase of that particular element (screen) loop that is playing and the PGG device software picks and plays another for the User to audition. The SKIP DRUMS is also an erase function, but the device moves the User to the next element screen with no drum loop playing. (If the User wants to hear the drum loop alone, i.e., without bass, the User would navigate to the DRUM screen first, select, audition and keep a drum loop by selecting YES, then navigate back to the BASS screen.)

Once a DRUMS loop has been kept by selecting YES, the PGG successively and automatically routes the User through subsequent element screens, auditioning and ultimately adding appropriate MELODY, BACKING, and SOUND EFFECTS (SFX) loops (tracks) from their respective loop library collections into the mix. Note, the left and right arrows at the bottom of the screen permit the User to navigate between the screens to change or add more tracks as desired.

At the end of the 5 or more track loop layering process the PGG device automatically brings the User back to the HOME screen, whereupon the User can SAVE, EVOLVE, try again by selecting CREATE, go into AUTOPLAY, or share by up/down loading the Groove just created. Note that the user may manually navigate to the HOME screen at any time in the compositional process, using the arrows at the bottom of the screen.

During the composition process, if before selecting YES at any given screen, the User decides to go back a screen, the current unsaved loop that was brought into the mix by the PGG device software is removed from the mix. The only loop(s) remaining in the mixed tracks once the User steps back before selecting YES are those that were kept (temporarily saved by selecting YES) at their respective screens. Then, upon returning to the initial given screen, another loop from that collection of loop elements would be randomly selected and layered into the prior kept other loops.

When the User steps through all the element screens, or is otherwise satisfied with the composition, he/she is automatically returned to the HOME screen (or navigates there via the arrows at the bottom of the screen). At this point, the Groove composition will be a multi-track, layered-loop musical piece, in a given key, tempo and style, which repeats every four bars. As noted, once on the HOME screen the User can SAVE the composition, DOWNLOAD it, or CREATE another Groove composition. PLAY and SAVE are both functions available on the HOME screen. SAVE will commit the metadata that describes the currently playing Groove (which is a single 4-bar multi-track composition) to permanent memory. Once it's in RAM non-volatile memory, the User can recall it via the PLAY function, which will rebuild the Groove from the metadata and play it (at which point it may be EVOLVED.) On the HOME screen, the User may also choose to EVOLVE the piece.

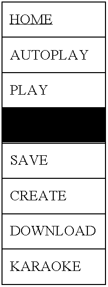

In the EVOLVE mode, once the User has created a basic 4-bar Groove, either by the AUTOPLAY or the CREATE function modes, when the User selects EVOLVE, the PGG device will play the composition while substituting one new loop of one element in the same tempo, key and style successively in the mix every four bars, which substitute loop is selected randomly from amongst compatible loops. The result is that the gradual successive substitution of one element every four bars will evolve a totally new Groove, a new mix, every 20 bars, assuming 5 loop parts or elements. If there were three loop parts the new Groove would emerge at 12 bars and if 8 loops, the new Groove arises at 32 bars. Further, the composition continues to evolve in 4-bar increments, forever (see FIG. 4 for a flowchart diagram of the “EVOLVE” function). Because these new loops are selected from among only those that match the key, tempo and style of the original loop, and because the substitution takes place gradually (one element every four bars,) the exchange of loop(s) will be perceived as a smooth, musically satisfying variation. In EVOLVE mode the PGG device will continue to play the piece indefinitely and continuously, producing a unified and coherent but ever-changing true “jam-session”-type performance. When a previously saved Groove is played in EVOLVE mode it will vary in one way, and when played again in EVOLVE, it will vary in another way. That is, the probability of two successive EVOLVE plays being the same approaches zero. Indeed, the number of EVOLVE variations is huge, thus providing enormous compositional variety, and accordingly enormous entertainment variety.

In still another embodiment, the EVOLVE screen can be configured to bring up another screen, or a drop-down menu on the HOME screen, in which the User can select to keep an evolving Groove for a length depending on the capacity of the volatile memory, by selecting YES, and optionally, a length, say 128 bars, 512 bars, 1024, etc, depending on the PGG device capacity. Then as it plays, the HOME screen showing, the User can select SAVE.

Back on the HOME screen, the User may also select the SAVE option. Invoking SAVE brings up the NAMING screen. Here the composition may be named (by selecting letters and numbers) and saved to non-volatile memory. Where a Navwheel is used, the wheel may include lateral toggling capability so that the wheel scrolls both across and down the alpha numeric list. In the alternative, this (and all others for that matter) may be pressure or capacitance activated, and a stylus provided to permit “tap-selection” of letters and numbers for the name of the composition.

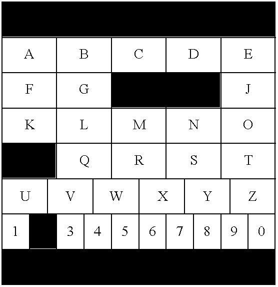

It is important to note that the resulting Groove composition is saved, not as a memory-hungry audio file, but as metadata: a tiny tag file that instructs the PGG device how to reconstruct the original four-bar composition on demand. Use of metadata permits saving evolved compositions as only the sequence of selections of successive loops is being recorded, not the sample loop files themselves as an audio file. Thus, the PGG saves the metadata of the selections made, either the auto-selections generated by the device when AUTOPLAY was selected, or the sequence of choices selected by the User when CREATE was chosen. This allows the storing of an enormous library of musical pieces with very little RAM memory, and it allows the User to re-EVOLVE the piece at any time.

Thus, by way of example, a particular, unique, complete Groove composition is saved for recall and playback to the speakers (in digital binary code string) as the identifying metadata: SJBS137D54M36BK92SFX80 (Style: Jazz; Bass loop #137; Drum(s) loop #54; Melody loop #36; Backing loop #92; SFX loop #80, rather than as audio files. The Style identifier may not be needed, as the loops chosen can be unique to the style, and the alpha can be coded numerically. Thus in a few bytes, the entire Groove composition can be saved to memory.

Once the piece has been saved, it can be recalled at any time using the PLAY command on the HOME screen. It will also be available for up/down load, facilitating community sharing of Groove compositions, editing, evolving and commentary, and in the Music Therapy and Education fields, for review by professional staff for psychological/emotional and musical content.

A typical created Groove index page showing the Groove compositions as named by the User is illustrated below:

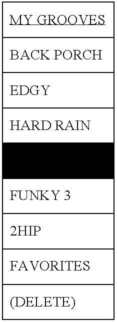

The device automatically returns to HOME, allowing the User to EVOLVE it if he/she wishes. Or, the User can navigate back to the MY GROOVES page and DELETE, if so wished, or PLAY a different saved composition.

When the Navwheel clicks down to Pink Dawn, it becomes highlighted (or the contrast bar shows). By depressing the Navwheel that composition is selected and begins to play. That screen stays up. The User can then scroll down to DELETE. Depressing the Navwheel again would delete the Pink Dawn selection from memory. If the User wanted to have Pink Dawn evolve, he/she would use the back arrow to go to the HOME screen, and there select EVOLVE.

The PGG can also be configured to track the number at times a saved Groove is replayed by the User. When the User selects FAVORITES, one of the “top five” or “top ten” most often previously replayed or the top 5 or 10 most often uploaded to the PijiSite (to date), is then reconstructed from metadata and replayed. At the same time, the HOME screen appears, allowing the User to EVOLVE, or DOWNLOAD (Upload to a site or P2P transfer), if desired. The User may also navigate back to the MY GROOVES page menu to select a different Groove, either manually or by re-invoking the FAVORITES option, in which latter case another of the top 5-10 Grooves would be randomly selected and played. Alternately, the PGG device can display, by name, the top 5-10 Grooves, and the User can scroll and select a Groove to play.

In the KARAOKE mode the User's voice, or an instrument or any other audio source is input via an external microphone and mixed with a previously saved Groove that is currently playing. The resulting vocal plus accompaniment mix is then output to the headphone/speaker port. In an alternative “PRO” embodiment, the vocal plus accompaniment mix may be saved as an audio file for replay or down/uploading. The audio file can be converted to a digital, compressed file, such as MP3-type file, and saved as such by the DAC chip in the PGG device.

With respect to the advantages and objects of the inventive system, the following chart outlines the features and functionality benefits, not only generally, but also for the specific use examples in the fields of Music Therapy and Music Education:

TABLE I
Objects and Advantages in Terms of Feature and Benefits Relationships

| | | BENEFIT | BENEFIT |
|---|---|---|---|
| FEATURE | BENEFIT | (Music Therapy) | (Music Education) |
| Requires no musical | Provides true musical | Extends music therapy | Involves non-musician |
| knowledge | composition capability | benefit to non- | students with active |
| | to all non-musicians | musician patients | music study |
| Requires no technical | Removes technical | Removes technical | Lowers “frustration |
| or computer skills | barriers to “electronic” | barriers to music | threshold” for non- |
| | music composition | therapy for all patient | tech-oriented students |
| | | populations | |
| Requires minimal | Provides true musical | Extends musical | Allows students to |
| physical interaction | composition capability | therapy benefits to | combine use and |
| | to all regardless of | physically challenged | enjoyment of device |
| | physical abilities | or convalescent | with physical activity |
| | | patients | (e.g. running) |
| Heuristic (device | Provides immediate, | Allows patient groups | Immediate, easily- |
| “learns” User | satisfying result, even | with learning issues to | achieved, satisfying |
| preferences in the act | on initial usage, | benefit from music | musical result |
| of composition) | without manual study | therapy | encourages apathetic |
| | or programming | | students |
| Auto-sync (User hears | Vastly simplified and | Easy-to-use | 1. Immediate |
| entire composition-in- | non-frustrating process | “transparent” interface | gratification of |
| progress while | of selecting and | encourages use among | apathetic students |
| auditioning new loops) | combining loops | all patient groups | 2. Provides teaching |
| | | | opportunity: e.g., “Why |
| | | | does that loop sound |
| | | | good/right?”) |
| Evolves compositions | After initial short | Encourages extended | Truly entertaining, |
| into full, extended | composition is | use and enjoyment | musically satisfying |
| pieces automatically | completed, User can | (ideal for | result encourages use |
| | listen indefinitely to | convalescents) | and further inquiry into |
| | intelligent variations | | music |
| Uses full instrumental | Full, realistic stereo | Musically satisfying | Encourages use and |
| sample loops (e.g. | delivery of “true” | and pleasant to listen | enjoyment, even |
| mp3s) as basic sounds | musical experience for | to, even over extended | beyond |
| instead of “cheesy” | deeper listening | periods, with little | classroom/educational |
| electronic tones | experience | aural exhaustion | environment |
| Allows direct, personal | True compositional | Engages “inner | Encourages interest in |
| musical expression | expression, rather than | person”, even in | earning to develop |
| | mere passive listening | withdrawn patients | one's own musical |
| | | | expression |
| Responsive to User's | Allows User to express | Provides valuable | Enhances enjoyment of |
| emotive state (“mood”) | mood and match the | diagnostic insight into | the entire experience, |
| | day's music to the | patient emotive state | encourages multiple |
| | day's mood | | uses |
| Saves compositions as | This allows the storing | Therapeutically | Favorite pieces become |
| metadata | of an enormous library | successful | source of pride, objects |
| | of pieces with very | compositions may be | of sharing, further |
| | little RAM memory for | reused | motivation and means |
| | later listening, editing, | | to extend study |
| | evolving and sharing | | |
| Saved compositions | Pieces may be stored, | Gives therapists a | Opens up |
| may be downloaded | shared, reviewed, | diagnostic window into | compositional process |
| | analyzed, edited, etc. in | patient's psychological | to social interaction |
| | various contexts (see | state. | and teacher |
| | below) | | participation, criticism |
| | | | and guidance |
| LAN-capable | Permits sharing, | Ideal in clinical or | Ideal in and beyond the |
| | criticism, mutual | ward situations, and for | classroom for group |
| | composition, etc., in | the extension of | and/or team learning |
| | local area | therapy beyond the | |
| | | clinical venue | |
| Global network | Permits sharing, | Allows therapist | Allows development of |
| capable (via Internet | criticism, mutual | interchange and | a website community |
| Website) | composition, etc., with | evaluation of patient | of fledgling composers, |
| | the world | output and history of | encourages further |
| | | use | study |
| Moderate | Provides unique but | Cost effective | Cost effective |
| manufacturing costs | affordable musical | therapeutic device that | alternative to |
| | composition to most | may be reimbursable | expensive instrument |
| | consumers | | or computer purchases |
| Small, lightweight, | Encourages use | Physically unobtrusive | Encourages students in |
| headphone-equipped | anywhere. anytime | and non-intrusive in | and beyond classroom |
| | | clinical or ward | to incorporate musical |
| | | conditions with full | composition in their |
| | | portability for “take- | entire lives. |
| | | along” use. | |

### BRIEF DESCRIPTION OF THE DRAWINGS

The invention is described in more detail with reference to the drawings, in which:

FIG. 1 is a front isometric view of the PGG device with the various external controls and ports identified;

FIG. 2 is a flowchart of the compositional process for both AUTOPLAY and User CREATE;

FIG. 3 is a diagram illustrating one embodiment of the loop database structure and the selection path logic flow sheet for creation of compositions; and

FIG. 4 is a diagram showing the evolve function changing an original User-selected composition of five types of loop elements into an entirely new composition.

### DETAILED DESCRIPTION, INCLUDING THE BEST MODES OF CARRYING OUT THE INVENTION

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention, including what is presently believed to be the best modes of carrying out the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

All publications, patents and applications cited in this specification are herein incorporated by reference as if each individual publication, patent or application had been expressly stated to be incorporated by reference.

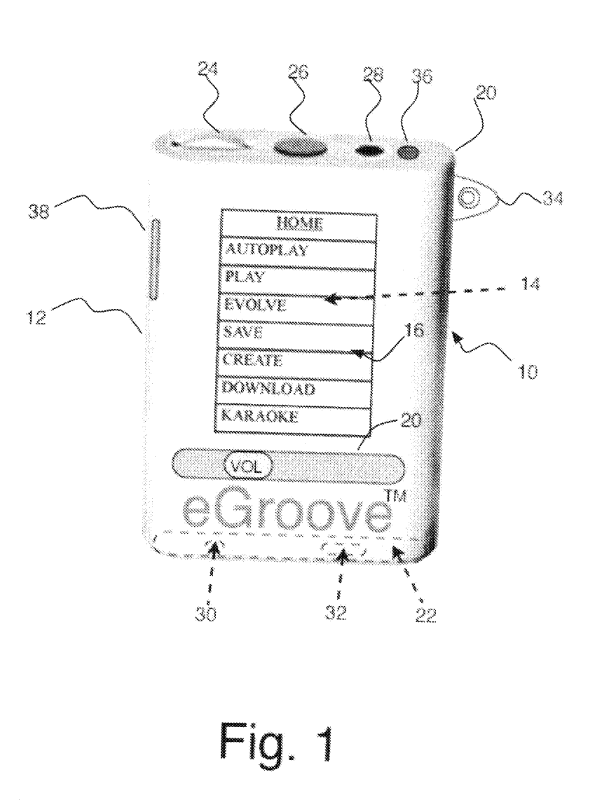

FIG. 1 illustrates a first embodiment of the apparatus aspect of the invention, a personal, portable media device 10 specially configured as a Portable Groove Generator. The PGG 10 comprises an attractive housing 12, shown in this example as similar in size to an Apple iPod or a Microsoft Zune media player. However it should be understood that the size of the device can vary widely, from PDA sized to very small, e.g., on the order of the size of a flash memory stick that may be hung on a keychain or a lanyard from the User's neck, tucked into a loop in an arm band or belt holster, or the size of a wristwatch. The size is generally dictated by the memory device used. For hard drives, the size may be on the order of an Apple iPod (approximately 4″×2.5″×½″) for 35-50 mm disk-using hard drives, to the size of an Apple Nano (approximately 1.5″×3.5″×¼″) for 25 mm hard drives. For smaller and ultra-compact form factors (1.5″×1″×½″ or smaller) flash memory is employed. Accordingly, where discussed in this first embodiment as using a hard drive, it should be understood that the device will function equally well with a static memory chip, which for some form factors, the shock resistance and longer battery life of flash memory will be preferred.

It is an important aspect of the invention that since the Grooves are stored in memory as metadata, that is, as a digital bit string representing loop style, elements and numbers (e.g., Jazz, Bass #52, Drums #212, etc) in sequence to be selected for playback, the amount of data representing the completed compositions is extremely small. MP3 is a digital version of an analog music file. However, the files are relatively quite large and an algorithm is used to compress the files for storage, and later to decompress them for re-conversion to analog for use by the headphones and speakers. A number of these CODECS (COmpression/DECcompression algorithmS) for compression/decompression of digital music files are available. Thus, each compressed MP3 loop is a small file, and the generated-Groove files are even smaller. A static memory chip in the instant inventive device can store thousands of Loops and Grooves, thus permitting ultra-compact device form factor. In addition, due to the small collective file size, the instant application software and database files can be easily added to devices having other principal functionalities, such as cell phones, MP3 players, laptops, Internet tablets, and the like. Indeed, the PGG device and/or software can be incorporated into a wrist watch.

In this embodiment, the front face shown includes an LCD or OEL screen 14, that may be black & white or color, which is typically disposed behind a protective transparent plate or window. The HOME page menu 16 is shown displayed on screen 14. A volume control device 20, in this embodiment shown as a slider, is disposed in the front face below the menu screen 14. Input/Output controls in this embodiment are disposed on the top and bottom faces 20, 22 respectively. On the top face 20 are located a menu navigation and selection device 24, here a Navwheel, an On/Off button 26 and an audio-out port 28, here a mini-jack for earbud headphones and/or auxiliary or dock-based speakers. Alternately, the navigation selector may be a rocking disk-style click wheel or the like. It should be understood that the volume control and the navigation device can swap positions; for example the volume control can be a slider or rotary wheel in the top face 20 and the navigation device a rocker disk located below the LCD or OEL screen. The software can paint the display in either portrait orientation, as shown, or, when the device is turned 90°, it can display in landscape, as selected by the User. In addition, the LCD/OEL screen may be a touch screen (finger or stylus actuated), so that the navigation device is not used or is optional. The bottom face 22 includes a power jack 30 for input of DC power from a transformer or battery, such as DC 3-12 volts, and the pin may be either + or − ground. Also included is a data port or docking port 32, e.g., a USB, Firewire or dock port. In this example, a Li-ion rechargeable battery is disposed within the housing that is recharged via port 30 by a cube transformer from 120V AC source (household current) or the equivalent DC European standard voltage. In an alternative, long life batteries for the protection of volatile files may be used, and no power port is used. Where the power port is used, the device can be run directly from that source; that is, a charge sensor may be used to permit direct powering from the input rather than the onboard battery. This permits use even when the battery is missing. A lanyard eye 34 is optional.

An optional microphone input 36 is provided (the mic is not shown) for the Karaoke mode. In the KARAOKE mode, the User selects a saved Groove, and sings along with it, while either listening through the earbud headphones, or external speakers. In one alternative, the PGG does not record the voice, it just provides the accompaniment. In a second, “Pro” embodiment, the singer's voice is converted to a digital MP3 file and overlain on the Groove's loop tracks and can be named and saved for replay.

In another embodiment, graphics may be displayed on the display screen 14, or displayed on an external display. The graphics may simply be a screen saver, static visual painted on the display, or be audio modulated and synchronized, e.g., as color tracks and patterns that are painted to the screen by an app that assigns colors and patterns to the digital values of the Groove or Loop file musical notes. In a typical example of the latter embodiment, a simple chip-based oscilloscope could generate a trace pattern that would in turn trigger a series of animated synthesized images that are based on the graphic pattern of the trace itself (typically a jagged line of “peaks and valleys), where such parameters as wave amplitude, frequency, complexity and consistency trigger visual analog components such as size, speed, color, and visual complexity. Alternately, musical parameters such as note pitch, volume, instrument category or musical style can trigger a simulated movie or slideshow of preloaded images (JPEG, PICT, TIFF, GIG, PDF, etc.) This embodiment may further allow the importation of User graphic files for inclusion in the simulated movie/slideshow. In the HOME screen an additional menu option may be added, called GRAPHICS, which when selected gives a sub-menu of several active, sound responsive graphics, such as Sine-Wave, Aurora, Radiation, etc. Upon selection of one, the program returns to the STYLE screen and the Groove generation process continues as disclosed above.

In still another embodiment, a video function is offered via the HOME screen menu option, VIDEO, and saved video files can be played along with the Groove music. A further embodiment includes GAME options, to display and permit playing of games, in which embodiment additional game function buttons are included on the face of the device below the screen. In this embodiment, the volume slider or control wheel may be placed on the side of the device of FIG. 1.

Internally, the arrangement of the electronics is straightforward, and providing a suitable component orientation is well within the expertise of those skilled in the art of portable consumer electronics device design. For example, a thin sheet, Li-organic polymer battery may be used that is essentially the full width and height of the case, and is disposed parallel to and just inside the inside face of the back case-half. The chips are mounted on a printed circuit board disposed in the case (not shown), and include a CPU, a volatile memory chip, and a Digital to Audio Conversion (DAC) chip. Suitable connectors between the board components and the input/output port and audio jack, on off button, the display, the memory device (hard drive or flash memory chip), the power supply (battery), the Navwheel and the volume control are provided.

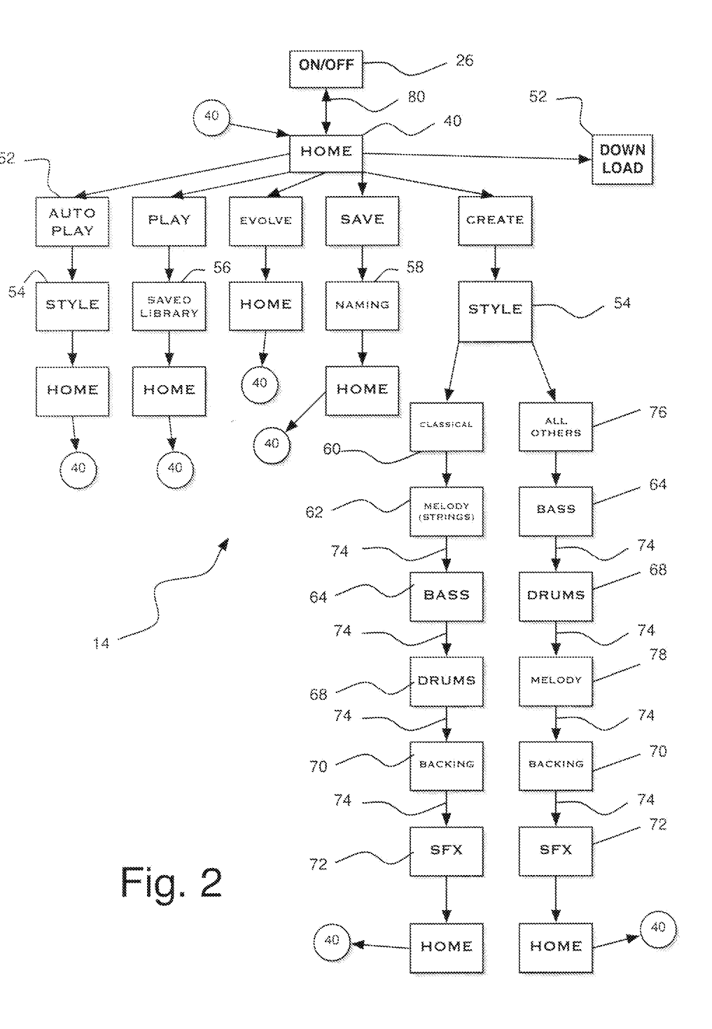

FIG. 2 is a flow sheet showing the architecture of the inventive software application for operation of the device. The displays on screen 14 have been described above, and may be referred-to again in connection with this figure. The device 10 (FIG. 1) is turned on by actuating button 26, at which time the home screen 40 displays the menu items AUTOPLAY 42, PLAY 44, EVOLVE 46, SAVE 48, CREATE 50 and DOWNLOAD 52. Selecting AUTOPLAY 42 automatically brings up the STYLE screen 54. Once a style is selected, as described above the device auto-creates and plays a random complete, 4-bar multi-element Groove that is repeated as long as the User wants to listen. The device also automatically returns the User to the HOME screen so the User can select one of the other menu options, such as SAVE or EVOLVE. If the User does not like that Groove, he/she selects AUTOPLAY, and the process repeats with an automatically created new Groove.

If the User selects the PLAY menu option 44, the saved Grooves list 56 is displayed, and upon selection of a Groove, that is played while the device returns to the HOME screen 40.

Selecting the EVOLVE menu option 46 initiates the evolve function, which is then applied to any one of an AUTOPLAY or a SAVED GROOVE (selected by name or other ID). The evolve function can also be applied to a newly created Groove after going through the CREATE function path (see below).

Selecting SAVE option 48 takes the User to the NAMING screen, where the User names the particular Groove created, upon which the HOME screen is again returned-to and displayed.

Selecting the CREATE option 50 first brings up the STYLE menu screen 54. Upon selection of CLASSICAL option 60, in succession the following screens with menus of options are displayed on screen 14: STRING MELODIES 60, BASS 64, DRUMS 68, BACKING 70, and SFX 72. Upon selecting or skipping (as described above) a Loop from the respective element libraries stored in device memory, each in sequence is layered and the User hears the increasingly complex and complete composition being built. The User is returned to the HOME screen 40, and after listening, can SAVE, EVOLVE, CREATE another Groove, etc.

Note that at each element screen 62-72, there are alternative selections of YES, which means to keep and move to the next screen which occurs automatically, TRY AGAIN which initiates the application program to select another Loop from that elements Library at random and play it for audition and approval (or not) by the User, and SKIP, upon which the program displays the next element screen and plays a random Loop from that element Library.

In the event the User selects at the STYLE screen 54, any other style 76, other than CLASSICAL, the BASS menu screen 64 is displayed first. The selection is made sequentially for DRUMS 68, then MELODY other than strings 78, BACKING 70, and SFX 72. Upon completion of the Loop track layering to produce the Groove, the User is returned to the HOME screen as before for those options.

An additional option, DOWNLOAD 52 is available by selection from the HOME screen. This initiates the browser for Internet upload of User-created Grooves, or download of other User Grooves or new Loop libraries from the GrooveSite (PGG site or PijiSite) or other provider. In addition, upon plug-in of the USB or Firewire cable in the device port, the server computer or other device detects the connection and prompts download to that other device, e.g., a laptop, cell phone, PDA, Internet tablet, PC or MP3 player.

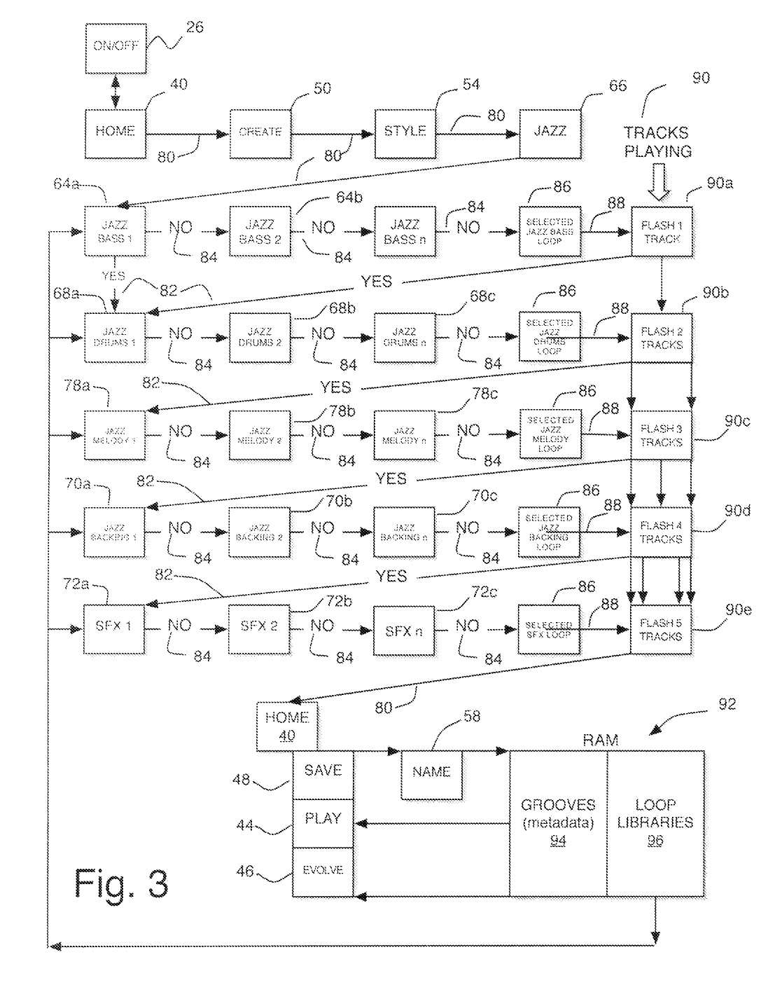

FIG. 3 is a flow sheet showing the architecture of the inventive software application functionality for operation of the device in the CREATE mode. The User switches the device ON 26, and the device automatically displays 80 the HOME screen 40. The User selects CREATE 50 from the screen menu, and the STYLE screen 54 automatically displays 80. In this example, the User selects the menu item jazz, and the JAZZ screen 66 is automatically displayed with its menu 74 of YES, TRY AGAIN, SKIP, and an automatically, device-randomly-selected, first jazz BASS Loop 64a plays for the User to audition. Each Loop is selected out of the Loop Library 96 in RAM 92 (hard drive or flash memory). If the User selects YES 82, the screen does not change, but a first, device-randomly-selected DRUMS Loop 68a is played as an overlay. If the User selects TRY AGAIN 84, shown as the NO arrow, then the device automatically plays a second randomly selected BASS Loop 64b. This is repeated to the Nₜₕ BASS Loop 64c, one that is eventually chose as the selected BASS Loop 86 by the User, by selecting YES on the JAZZ screen menu, whereupon the device writes-to volatile or rewritable flash memory 88 the selected Loop as the first track 90a. That BASS Loop track continues to play and the device then advances to a first, randomly selected DRUMS Loop 68a, which is overlain onto the BASS Loop playing.

The User steps through the same process for selecting a DRUMS Loop as with the BASS Loop, and the software directs the device functions of retrieval, random selection, playing and overlaying in response to the User selection input. When a DRUMS Loop is 68c is selected as suitable 86 by the User, that loop is written-to 88 the volatile memory to produce a two-track overlay 90b.

This procedure is iterated in sequence for JAZZ MELODY Loop 78a-78c to produce a 3-track overlay 90c, followed by JAZZ BACKING Loop 70a-70c to produce a 4-track overly 90d, and finally an SFX Loop 72a-72c to produce the final complete Groove composition, in this example a 5-track overlay 90e. While the Groove is playing, the software displays again the HOME screen 40 with its menu of options. There the User may select SAVE 48, whereupon the NAME screen is displayed 58, the User enters a name, and the Groove is saved to RAM in the Grooves Library section 94. Later, the User may retrieve that Groove from the Groove Library 94 by name, and PLAY it 44, or EVOLVE it 46.

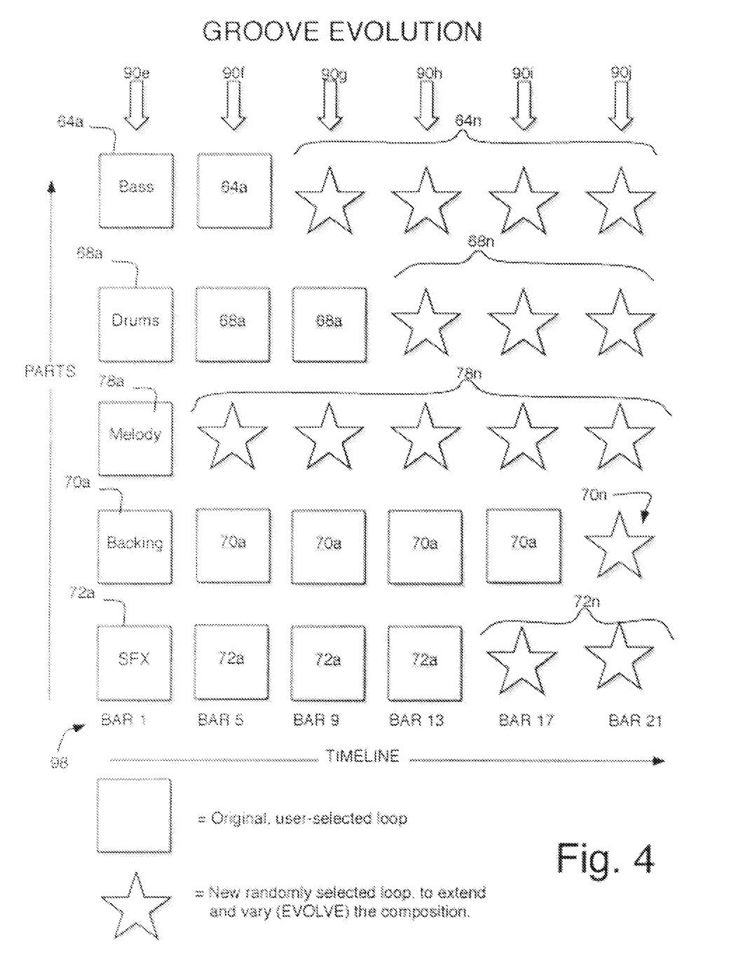

FIG. 4 is a flow sheet showing the architecture of the inventive software application functionality for operation of the device in the EVOLVE mode 46 of the composed Jazz style Groove of FIG. 3. The X axis represents a timeline 98 in terms of bars of Groove music, here 21 in all. The Y axis shows the component elements of the Groove 90e: BASS 64a, DRUMS 68a, JAZZ MELODY 78a, BACKING 70a and SFX 72a. The original Groove 90e continues for 4 bars as represented by the first column of the Y axis. Then at the start of the 5^{th} bar, the device randomly selects another JAZZ MELODY Loop 78n from the Loop Library 96, and overlays it onto the remaining 4 tracks to produce a changed (partially evolved) Groove 90f. That new JAZZ MELODY 78n continues in the composition to bar 25 (at least). At bar 9, the device randomly overlays a new BASS Loop 64n which creates a further changed Groove 90g. At bar 13, the DRUMS Loop is changed to 68n creating Groove variation 90h, and so on with SFX Loop changing at Bar 17 to create Groove variation 90i, and finally an entirely changed composition Groove 90j is created by bar 21 by the overlay of a new BACKING Loop 70n. If the User continues in the EVOLVE mode, the process is repeated with an entirely changed (all elements or parts are new) Groove evolving every 21 bars. Each entirely new Groove plays for 4 bars before beginning to musically evolve again. It should be understood that the rate of evolution, every 4 bars in this example, can be shortened, lengthened or randomized, either automatically by pre-configuring the software or by providing a User-selected menu choice in the EVOLVE screen choices. In addition, since the device either stays or can be returned to the HOME screen once EVOLVE is selected, the User can select SAVE when he or she hears a particular Groove variation that they like, and that variation playing at that moment, will be saved, via the NAME screen.

In one important aspect of the invention, the inventive PGG device and Groove Composition software can be used by more advanced, musically trained Users, for example as a “Sketch” pad to create Grooves, and save them for download to a conventional MIDI file based digital music composition program. The on-the-fly created Grooves can then be used as inspiration, or for enrichment by conventional digital composition software. In addition, the Groove Composition software, in an alternate embodiment, includes the ability to double Loops, that is add a second BASS, DRUMS, etc. Loop to make more than a 5-track Groove Composition.

### EXAMPLE 1

### PGG Use in Music Therapy

Music Therapy is today a recognized and accredited medical specialty throughout the world. In the U.S. alone, the American Music Therapy Association (the largest professional association) represents over 5,000 music therapists. A visit to the Association's website at http://www.musictherapy.org/ will document the scope and degree of acceptance of the discipline. It states: “Music Therapy is an established healthcare profession that uses music to address physical, emotional, cognitive, and social needs of individuals of all ages. Music therapy improves the quality of life for persons who are well and meets the needs of children and adults with disabilities or illnesses. Music therapy interventions can be designed to:
promote wellness
manage stress
alleviate pain
express feelings
enhance memory
improve communication
promote physical rehabilitation.”

The AMTA identifies patient groups who benefit from musical therapy as follows: “Children, adolescents, adults, and the elderly with mental health needs, developmental and learning disabilities, Alzheimer's disease and other aging related conditions, substance abuse problems, brain injuries, physical disabilities, and acute and chronic pain, including mothers in labor.” The use of music in these and other therapeutic areas is well documented and established as shown by the following exemplary quotes: “Almost all children respond to music. Music is an open-sesame, and if you can use it carefully and appropriately, you can reach into that child's potential for development”, Dr. Clive Robbins (Nordoff-Robbins Music Therapy Clinic); “(Music Therapy) can make the difference between withdrawal and awareness, between isolation and interaction, between chronic pain and comfort—between demoralization and dignity”, Barbara Crowe (past-President, National Association for Music Therapy); “Music therapy has been an invaluable tool with many of our rehabilitation patients. There is no question that the relationship of music and medicine will blossom because of the advent of previously unavailable techniques that can now show the effects of music.”—Mathew Lee (Acting Director, Rusk Institute, New York).

The ability of music therapy specialists and support staffs to deliver these benefits is hampered in today's medical environment by two interconnected challenges: critical staff shortages and growing patient populations. This is exemplified by the following quotes: “We are an aging population, a growing population, and our physician supply has not kept pace with the growth”, Dr. Jordan Cohen, The Association of American Medical Colleges; “Some 126,000 nursing positions in the United States are unfilled and the lack of staff is putting patients' health in grave danger”, 2004 Report by the Joint Commission on Accreditation of Healthcare Organizations; “In 1998, there were about 9,000 geriatricians. Today there are just 6,700. This is going to be the Hurricane Katrina of 2020. The cost of caring for these older people is going to be enormous”, Dr. David Reuben, President, American Geriatric Society.

The patient populations who benefit from music therapy include children, adolescents, adults, and the elderly with mental health needs, developmental and learning disabilities, Alzheimer's disease and other aging related conditions, substance abuse problems, brain injuries, physical disabilities, and acute and chronic pain, including mothers in labor.

Broadly speaking, music therapy techniques are used to achieve a number of goals:
To assess emotional well-being, physical health, social functioning, communication abilities, and cognitive skills through musical responses;
To “reach” withdrawn or unresponsive patients;
To socialize these patients;
To relieve depression; and
To soothe pain.

At present, musical therapists face several challenges in dealing with patient groups to achieve those goals:
Physical and cognitive challenges that render even rudimentary musical performance difficult or impossible;
Emotional or psychological states that render the patient withdrawn or unresponsive;
Active musical expression (as opposed to mere listening) is often confined to formal sessions, particularly in clinical contexts; and
Budgetary limitations, staffing cuts and growing patient populations undermine the time and attention that therapists and support staff can spend with patients.
   Use of the PGG will ameliorate these conditions in the following ways:
1. The PGG User interface requires minimal physical interaction, and the transparent simplicity of the composition process encourages broad usage even by the most challenged patient populations.
2. As a personal expression of one's “inner composer”, the PGG will facilitate communication with hard-to-reach patients.
3. The PGG can be used in privacy with headphones by most patients in most clinical or convalescent settings.
4. The PGG requires minimal direct staff involvement after a rudimentary introductory session. Most PGG sessions can be conducted by an aide, assistant, or clinician, relieving higher-level specialist staff for other duties, or by the patients themselves, with a preserved record of use. Actual compositions can be downloaded at any time for analysis.
   Further, in a music therapy context, the PGG provides the following additional unique benefits:
5. As an indicator of mood, the PGG will provide a powerful insight into patient emotional/psychological/cognitive states.
6. The PGG will provide agitated patients the calming benefits of individually optimized music therapy over a longer period with minimal requirements for staff oversight.
7. PGG's networking capabilities will enhance the socialization process.
8. Physically challenged patients who could previously only benefit from passive listening modalities will now have an active, creative expressive option.
9. Pain patients will enjoy an ongoing absorptive experience that will not be taxing or fatiguing, or intrusive to others.

### EXAMPLE 2

### PGG Use in Music Education

Traditional music education today is under severe staffing and budgetary pressure. For example, The Center for Education Policy reports that 22% of school districts have reduced instructional time in music and art to make more time for reading and math. Thus, for music educators operating under severe budgetary restraints, the PGG will offer an inexpensive means of introducing students to the compositional process, a powerful motivator for students formerly apathetic to formal music study, and a valuable tool for networking in and beyond the classroom.

The professional music educator, whether in a public or private setting, faces two very significant challenges in today's educational environment.
1. Student motivation. Since music ed. is a valued but declining course of study, the music educator faces an uphill struggle with the majority of primary and secondary students who, while avowedly fond of music (at least “their” music) are generally indifferent if not hostile to the commitment and rigors associated with traditional courses of musical study. This inborn reluctance is only exacerbated by the ubiquity of canned music readily available, indeed, virtually inescapable, in our society.
2. Budget cuts. Across the country, music (and other arts) curricula have been eliminated or pared to the bone. Salaries and operating budgets have shrunken drastically, teaching staffs have been reduced, and funds for such “non-essential” purchases as instruments and sheet music are virtually unavailable in most school districts. Recent federal mandates tying funding to performance in “core curricula” (reading, math and science) have had the unintended effect of reducing still further the funds and staff provided for music education.

The current state of music education in California is typical. A newly released report, The Sound of Silence—The Unprecedented Decline of Music Education in California Public Schools unveiled a 50 percent decline in the percentage of students in music education programs over the past five years, representing an actual student loss of over one-half million students. Over the same period, the number of music teachers has declined 26.7 percent for an actual loss of 1,057 teachers.

The declines in music education enrollment and teaching positions far exceed those in any other subject. The new report, produced by the Music for All Foundation, examined actual enrollment data from the California Department of Education covering the period 1999-2000 school years thru the 2003-2004 academic year. The Key Findings:
During the period when the total California public school student population increased by 5.8%, the percentage of all California public school students involved in music education courses declined by 50%. This decline is the largest of any academic subject area.
Actual student participation in music declined by 46.5% representing a loss 512,366 students. This decline is the largest of any academic subject area by a factor of four. (Physical Education is second with a decline of 125,000 students representing a drop of 5.2% of the total PE enrollment)
The number of music teachers declined by 26.7%. This represents an actual loss of 1,053 teachers.
Participation in General Music courses (those courses designed to bring basic music knowledge and skills to young students) declined by 85.8% with the loss of 264,821 students. This represents over half of the total decline of participation in all Music Courses. This is followed by declines in Other Music Courses (−48.5%, −103,783 students), Chorus (36.1%, −57,905 students), Band (−20.5%, −44,509 students), and Instrumental Lessons (−41.4%, −39,792 students).
When student participation declines are compared to other academic subjects, Music tops the list. The decline in music participation (−46.5%, −512,388 students) leads all other areas including Physical Education (−5.24%, −125,156), Health (−12%, −31,660), Humanities (−37.5%, −25,622), Safety (−9.13%, −6,983), and Computer Education (−0.7%, −1,866). Art, Drama, Dance, Foreign Languages, Social Sciences, Science, Math and English all posted gains during the period.

In order to offer any semblance of music education to students, today's music educator must maximize staff efficiency while minimizing budgetary outlay, yet still offer a program compelling enough to wean non-musician students from prerecorded music and MTV. The PGG makes a substantial contribution to this effort, inter alia, by motivating students in several ways:
1. The physical form factor will be familiar, non-threatening, and immediately attractive to a generation that is transfixed by MP3 players, cell phones, game consoles, and other personal portable electronic entertainment devices.
2. The PGG will compose in a broad range of styles, including currently popular forms to initially attract the young (rock, hiphop, etc.) and the more demanding “legitimate” styles (classical, jazz, etc.) that music educators seek to introduce.
3. The simplicity of the device will remove “difficulty” barriers for students with minimal musical and technical background.
4. The immediacy of musically pleasing results will gratify students and encourage them to delve deeper.
5. The opportunity to create one's own music, expressive of one's own mood and taste, will be a powerful attractant to a generation that worships “real” musicians.
6. The “sharing” aspect of the PGG, via LAN or Internet community, is another compelling yet familiar and highly accepted feature for today's students.
   The PGG will help to maximize staff time and budgetary efficiency as well:

1. Initial cost is very low, especially as compared to the cost of instruments and sheet music.
2. Maintenance costs: zero.
3. LAN capability allows a single teacher to instruct and monitor class activity, and to do so with a highly individualized pace of learning.
4. Initial training time is minimal, and an entire class can be introduced to the device together in a single session. In fact, introductory sessions could be conducted by classroom volunteers with minimal training and no certification.
5. Because an instructor can download and store student compositions, evaluations can be done after class hours, homework can be individualized and readily distributed to the individual student.
6. “Advanced” operations, such as critical analysis and group composing, can be accomplished by an entire class with a single instructor, or alone.
7. The portable, inexpensive nature of the device is ideally suited for homework.

Beyond the PGG device value as “bait” to attract students to music education, the PGG will be an effective teaching device, since:
1. A PGG Groove composition is an effective entry point for full discussion of all the elements of music: melody, harmony, rhythm, etc., creating an effective bridge from “music appreciation” to musical study.
1. A given groove also opens the door for discussion of composition theory; i.e. “Why does this guitar melody sound good (or bad) with this bass line?)
2. Composing on a PGG device is a powerful motivator to begin formal instrumental study. “How would you like to leave off the guitar part and play it yourself on a real instrument?”
3. The PGG GUI serves as a introduction to the art and craft of multi-track recording as well.

### EXAMPLE 3

### Internet-Enabled Loop Library & User Groove Distribution Method—Operational Example

The invention also includes an Internet-enabled method of Loop and Groove distribution comprising provision of at least one web site, called the GrooveSite, or PGG Site, or PijiSite, having a plurality of pages that include functionality for the site visitors, as PGG device Users, to upload Grooves that they have generated for community posting for free sharing by all who access the Site, or to a more restricted group of subscriber members. In addition the Site offers direct, free P2P Groove sharing, and the opportunity for members or subscribers to download new loop (or/and Groove) libraries developed by the Site content provider. The Site optionally includes functionality for offering and operating a wide variety of additional community and information services, such as: news; Blogs by members; ranking of popularity of shared Grooves created by visitor, member or subscriber Users (e.g., based on download counts); publicity about affiliate, sponsor or advertiser products and services; events relating to the PGG-community such as clubs, contests and conventions; memory upgrades for PGG devices; availability of the inventive Groove-generating software on other devices such as cell phones, PDAs, laptops and desktop computers, and game consoles; audio and video streaming of Grooves and events, and the like. One important aspect of the inventive business method system is that the Site can accumulate, and offer to conventional MP3 player owners, downloads of User or Site content provider-generated Grooves, at a price far below the conventional pre-recorded music download service. Indeed, where the Site Users provide the individually authored Grooves, the downloads may be offered free, thus avoiding DRM problems. Further, the site offers for sale additional downloadable libraries of loops, allowing Users to broaden the available menu of instrumental phrases and ambient sounds to enrich their compositions. In addition, the Site can offer to the installed base of MP3 player community, the Groove Composition Software so that their MP3 players can be converted to PGG devices, thus joining the PGG Community.

The Site is enabled and supported by a complete computer system, including having appropriate software for: management of operations; visitor, member and subscriber communications; hit and download counting, tracking and analysis; new loops creation; loop database management; member and subscriber relations; membership and subscriber database creation; link posting and management; site-User-name, sign-in and password protocols and templates; site member musical preference profiles, and other profile types that may be requested or offered from time to time; EULA agreements and violator policing or lock-out; security for payment processing, e.g. SSL; messaging including e-mail and IM; web pages creation and posting; visitor, subscriber, member, affiliate and advertiser billing; and the like. Examples include Groove download analysis programs that monitor the genre, style and type of Grooves or loops downloaded or/and uploaded, or products/services purchased, all by Users categorized on local, regional and national basis, gender, age, and other metrics chosen from time to time to generate statistics for prospective and actual advertisers. This can be done on a daily (or shorter or longer basis) to spot new musical trends for the music and A/V industries. The Site also includes a messaging program that functions to provide messages to the Site members (who include free Users and subscribers) on their selected preferences of loops, Grooves, styles and musical elements, products and the like. The hosting Site facilitates Users sharing the Grooves they have generated either P2P or via a community “page”, and further provides communication tools to generate, transmit and receive, archive, search, order (arrange, sort, rank, etc.) and retrieve Groove and loop information to multiple Users, including information personalized for particular Users of the Site. Income to the Site entity is generated through subscription and membership revenues, sale of new Loop Libraries, publications and events revenue, operation of affiliate and advertiser services, click-through fees and commission sharing with outside affiliates and advertisers, sale of Site-licensed memorabilia and products (PGG devices, memory upgrades, clothing, event tickets and the like), basis point selling agreements with content providers and other sites, and Site, page or Blog operating commissions and sales, and the like.

Optionally, prizes may be awarded by the Site Host, Site Sponsor, content provider or one or more affiliates or advertisers, for Best Grooves Uploaded, e.g., based on User download or sharing statistics, a complete set of rules is implemented to assure the popularity is accurately determined. In one aspect of the inventive business method, Grooves offered for sharing are streamed to a Site member via flyover of a posting of the Groove name. To prevent gaming, a cookie is deposited with every visitor, and each PGG device includes an ID code string or metadata string, so that multiple visits by the same Site visitor are not counted, or are not counted after an arbitrary number, say after the 3^{rd} visit. In addition, the submitter may not vote for his/her own Groove submitted in the contest or for sharing popularity ranking. The Site also can track multiple “winners”, so that especially creative Groove makers can create a following among fans.

The processes underlying the Site operation, communications with site visitors and member-investors and the Internet-implemented business method as described herein may be implemented in software as computer-executable instructions that, upon execution, perform the operations described. The Web server(s) of the GrooveSite may be implemented as one or more computers configured with server software to host a site on the Internet, and that implement the serving of static, generally informational Web pages, and that generate and serve dynamic Web pages tailored to facilitate the delivery of the services and methodology described above, including serving dynamic pages tailored to individual member Site members that may be generated on the fly in response to individual requests from the members via their Internet linked access devices (PGG devices, laptops, desktop computers, PDAs, cell phones, game consoles, etc.). As noted the PGG device includes browser and player software to effect the linking, up/down loading and A/V streaming to the Site via the Internet or the World Wide Web, Web-2, or the like. The PGG device optionally includes WiFi capability in suitable hardware, firmware and software functionality.

The Site enabling computer(s) of the invention can be configured in a system architecture, for example, as one or more server computer(s), database computer(s), routers, interfaces and peripheral input and output devices, that together implement the system. A computer used in the inventive system typically includes at least one processor and memory coupled to a bus. The bus may be any one or more of any suitable bus structures, including a memory bus or memory controller, peripheral bus, and a processor or local bus using any of a variety of bus architectures and protocols. The memory typically includes volatile memory (e.g., RAM) and fixed and/or removable non-volatile memory (e.g., ROM, Flash, hard disk including in RAID arrays, floppy disc, mini-drive, Zip, Memory stick, PCMCIA card, tape, optical (CD-ROM, etc.), DVD, magneto-optical, and the like), to provide for storage of information, including computer-readable instructions, data structures, program modules, operating systems, and other data used by the computer(s). Where multiple computers are linked to enable the Site, a network interface is coupled to the bus to provide an interface to the data communication network (LAN, WAN, and/or Internet) for exchange of data among the various Site computers, routers, and investor computing devices. The system also includes at least one peripheral interface coupled to the bus to provide communication with individual peripheral devices, such as keyboards, keypads, touch pads, mouse devices, trackballs, scanners, printers, speakers, microphones, memory media readers, writing tablets, cameras, modems, network cards, RF, fiber-optic and IR transceivers, and the like, A variety of program modules can be stored in the memory, including OS, server system programs, HSM (Hierarchical Storage Management) system programs, application programs, other programs modules and data. In a networked environment, the program modules may be distributed among several computing devices coupled to the network, and used as needed. When a program is executed, the program is at least partially loaded into the computer memory, and it contains instructions for implementing the operational, loop and Groove compositional, archival, sorting, screening, classification, formatting, rendering, printing and communication functions and processes described herein.

The Site-member uploads of Grooves, download of loops and Grooves, sales data, member data, etc., are stored in one or more sets of data records, which can be configured as a relational database (hierarchical network, or other type database) in which data or metadata link records are organized in tables, which records may be selectively associated with one another pursuant to predetermined and selectable relationships, so that, for example, data records in one table are correlated to corresponding records for the member (or loop, download popularity, etc) in another table and the correlation or individual datum is callable for rendering on screen, printout or other activity pursuant to the inventive method and system. The hosting site facilitates User Groove generation, and managing User and community sharing and communication events and activities, and provides both analytic tools that facilitate the analysis of the User activity, and communication tools to generate, transmit and receive, archive, search, order (arrange, sort, rank, etc.), retrieve and render loops, Grooves, and communication to multiple Users, including information personalized for particular Users.

A wide variety of Discussion Boards/Bulletin Boards (BBs) may be facilitated, e.g. public boards where comments about loops, loop libraries, Grooves, rankings, products and services, and comments are posted in as received real time on topics of the member-poster's choosing; club boards, style boards, product boards, individual members boards, etc., wherein a member posts a comment, observation, loop pick, reasons for a particular combination within a style or rhythm, or the like, and visitors or other members post comments in reply, and the like. A “Contact Us” link is provided for members to input comments, suggest improvements to the Site, and the like. Member, or broader community BB's may have sub-categories, depending on User interest. The Site can be rolled-out in stages or phases, and will typically evolve and change with and be responsive to the User member interests. In that aspect the Site is interactive on a musically creative level.

Completion of registration requires the User to agree to a EULA agreement comprising rules and conditions of Site access, authorization to access account, and service review and acceptance. Visitors and members are offered a template for them to enter a friend or acquaintance's e-mail address and the Site sends them an invitation to join. It should be understood that underlying the business method of the invention are conventional computer systems and operations, which run the appropriate Site management, sales, sharing, database, analysis and communication software that includes the functionalities disclosed. Based on the disclosure herein of the business model and system operations functionality, one skilled in the arts of information technology systems and management, and computer programming will be able to select, provide and integrate appropriate commercially available computer hardware configurations, operating system programs and application programs, and, as needed, create such additional code as may be required to execute the functionality described in a wide variety of formats. In this regard, note that the computer systems and operations spans and facilitates all the visitor, member, subscriber and public communication interactions and back room operations of the inventive business model and system of the invention.

For back office operational analysis, it is within the scope of the invention that the site communications to members and between members can be tracked and mapped, the result being a “network” interconnection diagram which reveals the information traffic flow in the site/system PGG device User universe, and identifies critical nodes for information flow bottlenecks or sources and direction of flow of information of high current interest. This analytic tool assists in management of information flow, and design of the architecture for operation of site hierarchical information transfer, and data management and storage systems of the invention. The inventive Site computer system software includes system control, all processing, User preference and activity results analysis and reports generation, and the rankings and contests operation and prize awards, operation of the discussion boards, including multiplex sorting, exchange of messages, postings, uploading and downloading, all communications between the parties using the system, member and subscriber contacts, registration and communication, the operation and management of the data base(s) including ongoing analysis of the data base structure and storage, search and retrieval performance, and other operations, including but not limited to site sponsor and investor/shareholder relations and corporate operations and record keeping, advertising and promotions, financial operations including billing and collections, IT operations, and other management operations and functions.

It is an important aspect of the invention to build a large subscriber base, from which a stream of subscriber revenues can be generated. The subscriber base is built through the Site home pages wherein a suite of Observer and/or Member services, are offered, some on a free basis and some on a fee-for-service basis. For example, the right to observe and access to post questions or information to certain discussion boards can be offered free, while the new Loop Library download offers can be offered on a subscription or fee for use basis. These subscriber services begin with the initial Site roll-out, and subscribers can come aboard at any time. The suite of services can shift and expand as the members move into active sharing, BBs, community events and the like. As noted, the initial contact and access of subscribers to the Site is via the Internet, with suitable registration, billing and password controls. Special e-mail accounts, can be set-up free, on a fee basis for more current, pop-up ad-free, e.g., instant messaging-type communications.

It should be understood that the relationships and functions described herein are not meant to be exhaustive of the typical and future relationships in Site operation and management, but are outlined herein to illustrate the business method of the invention and the Internet-based system having the designed functionality and capability of full service, PGG-device and Groove generation-related Site creation and operation. Thus, the Site operational company either creates content or provides it as a distribution entity.

### INDUSTRIAL APPLICABILITY

It is clear that the inventive music composition system of this application, comprising both software and hardware, has wide applicability to the consumer electronics and entertainment Indus-tries, namely to MP3 players, cell phones, PDAs, game consoles, computers and the like. The PGG device is a new technology modality that will be popular with the general public as it provides a simple, enjoyable way to permit the novice User with no musical training to compose a huge library of User-generated compositions that are musically complex and complete.

The PGG device will also, in view of its simplicity and ease of use for handicapped, disabled, elderly persons and children, be especially useful to serve as a diagnostic/therapeutic aid to music therapists and other medical practitioners who treat certain patient populations (e.g. ADD, autism, Alzheimer's, depression, convalescents, etc.) who will benefit from its unique features and benefits. The PGG device will provide an effective way to reach these patient populations, a new “diagnostic window” into patient mental and emotive states, and a means to deliver the documented benefits of music therapy to patients whose physical or psychological i would otherwise deny them such benefits.

Thus, the PGG device and software will achieve wide acceptance in a specialized therapeutic market that is driven today by critical shortages in medical staffing. The PGG device can be utilized by all target patient populations with no or minimal supervision, freeing key staff specialists for other duties.

The PGG device will also provide unique and valuable benefits to music educators in public and private institutional settings, as well as instructors who teach on an individual basis. The contemporary image of the device and its unequaled ease-of-use will prove attractive and non-threatening to under-motivated students. Furthermore, the PGG's relatively low cost will allow schools to make maximal use of staff time with minimal effect on shrinking budgets.

The PGG device is the first in a new category of personal electronic devices: the Groove Generator. Variously embodied as a standalone handheld device or as a sub-program within cellphones, PDAs, MP3 players, etc., the PGG composition software will allow Users with absolutely no musical or technical background and minimal physical capabilities to create, enjoy, save and share an infinite number of unique, complex, evolving multi-track (multi-loop) musical compositions in a wide range of styles with a few simple menu commands.

It should be understood that various modifications within the scope of this invention can be made by one of ordinary skill in the art without departing from the spirit thereof and without undue experimentation. For example, the PGG device can have a wide range of designs to provide the functionalities disclosed herein. Likewise the software may be enhanced, improved or modified to add to it additional functionalities, or provided as a sub-program, application program or sub-routine to existing application or operational programs that function in a wide variety of devices that include micro-processors or CPUs. This invention is therefore to be defined by the scope of the appended claims as broadly as the prior art will permit, and in view of the specification if need be, including a full range of current and future equivalents thereof

1. In a portable music player device having MP3 music file playing functionality including: a display screen; a menu navigation device for User selection of items displayed on said screen; a digital to audio converter for converting digital files to audio output to speakers; a central processor unit configured with an integrated computer control software system for operation of the functions of said player device; and at least one computer-readable memory device having a data storage structure including at least one database containing a plurality of digital data files representing music; said software system including an application program structure providing functionality for play of said digital music files; the improvement comprising in operative combination:
a) said database structure of digital data files includes a library of digital data files representing music loops organized in said database by musical element categories selected from bass, drums, melody, and at least one of backing and sound effects;
b) an application program structure in said memory having component architecture code processed by said central processor unit so as to retrieve individual loop data files from among said musical element categories, in at least one mode selected from:
i) automatic random selection; and
ii) User selection;
c) said application program code causing said central processor unit to overlay said loops to generate a multi-track musical composition groove, in at least one mode selected from:
i) a sequential, cumulative, loop-by-loop overlay build-up to create a musical composition groove; and
ii) a complete, simultaneously overlaid, multi-loop musical composition groove;
d) said application program code causing said central processor unit to automatically play said overlaid loops at each stage of layering;
e) upon User selection to either save or play, said application program code causes said central processing unit to:
i) scan source data of a completed groove to create or extract metadata from said scanned groove, and store in said memory as a data file structure, metadata representing the loop elements of said groove, rather than an audio data file, for playback by a User; or
ii) reconstruct from said stored metadata file for replay, said groove composition by recalling and re-layering of loops from said loop library pursuant to instructions in said metadata file and play said reconstructed musical composition groove; and
f) said application program code causes said central processor unit to: save and playback said groove compositions upon selection by said User; write displays to said screen representing at least one of menu items, graphics and video; store in memory reference objects selected from loops, grooves, graphics and video with links attached to said reference objects to provide automatic organization, storage, audio playback, indexing, and viewing in said display, and to permit a User having no significant level of musical or technical skills, or physical dexterity, to create a complete and rich musical composition groove.

2. An improved portable music player device as in claim 1 wherein said loops in each category are musically compatible in key, tempo and style, and are at least four bars in length.

3. An improved portable music player device as in claim 2 wherein said device application program code causes said central processor unit to evolve a selected saved musical composition groove and to play said evolved groove for audition by a User.

4. An improved portable music player device as in claim 3 wherein said device application program code evolve function comprises randomly deleting at least one of said musical category loops and substituting at least one other loop from the same category in place of said deleted loop, and said deletion and substitution is repeated after each new loop has been played for each of the remaining element categories of loops in said original groove composition.

5. An improved portable music player device as in claim 2 wherein in said User selection mode, said application program structure code, upon selection by a User of a create mode, causes said central processing unit to:
a) randomly select a loop from said loop library of a first elements category and play it repeatedly until accepted or not by said User;
i) upon non-acceptance, to randomly select a second loop from said elements category, recall and play it until accepted or not by said User;
b) upon acceptance of a given loop that is played, to randomly select a loop from said loop library of a second loop elements category, overlay it on said first loop and play the combined multi-track loops repeatedly until accepted or not by said User; and
c) repeat this random selection, overlay and play back of successive overlain loops in additional elements categories until a complete musical composition groove is produced by said device.

6. An improved portable music player device as in claim 5 wherein said device application program code causes said central processor unit to evolve a selected saved musical composition groove and to play said evolved groove for audition by a User.

7. An improved portable music player device as in claim 1 wherein said device application program code causes said central processor unit to transfer said saved metadata file representing the loop elements of a groove to another device via at least one of writing to removable flash memory, wireless transmission, or hardwire connection via a data port.

8. An improved portable music player device as in claim 1 wherein said device application program code includes browser functionality to cause said central processor unit to transfer at least one metadata file representing the loop elements of a groove to a website or another device via the Internet.

9. An improved portable music player device as in claim 1 wherein said device memory includes capacity to accept and add or replace additional loop and groove libraries.

10. An improved portable music player device as in claim 1 wherein said device includes at least one component selected from a data transfer port, a flash memory card slot, a dock connector, a rechargeable battery and battery recharge connector, a color display, display menu item selector device, a volume control, an auxiliary audio output port, an earbud-type headphone minijack, a wireless transceiver, and said device application program code causes said central processor unit to provide automatic operation of said components.

11. Method of generation of musical composition grooves in a portable electronic music player device by a User having no significant level of musical or technical skills, or physical dexterity, comprising the steps of:
a) providing in said device, a database structure having a library of digital data files representing music loops organized in said database library by musical element categories selected from bass, drums, melody, and at least one of backing and sound effects;
b) retrieving individual loop data files from among said musical element categories, in at least one mode selected from:
i) automatic random selection; and
ii) User selection;
c) overlaying said loops to generate a multi-track musical composition groove, in at least one mode selected from: a sequential and cumulative loop-by-loop overlay build-up to create a complete and rich musical composition groove, and a complete simultaneously overlaid multi-loop complete and rich musical composition groove, and to automatically play said layered loops at each stage of layering;
d) upon User selection to save a completed musical composition groove:
i) scanning source data of a completed groove to create or extract metadata from said scanned groove;
ii) storing in a digital memory in said device as a data file structure, said metadata representing the loop elements of said groove, rather than as an audio data file, for playback by a User; and
e) upon User selection of said groove composition for replay, reconstructing said complete and rich musical composition groove from said stored metadata file by recall of loops from said loop library and re-layering them for playback pursuant to said metadata file; and
f) said method permitting a User having no significant level of musical or technical skills, or physical dexterity, to create a complete and rich musical composition groove.

12. Method of generation of musical composition grooves in a portable electronic music player device as in claim 11 which includes the step of providing said loops in each category as musically compatible in key, tempo and style, and at least four bars in length.

13. Method of generation of musical composition grooves in a portable electronic music player device as in claim 12 which includes the steps of evolving a selected saved musical composition groove and to playing said evolved groove for audition by a User.

14. Method of generation of musical composition grooves in a portable electronic music player device as in claim 13 wherein said step of evolving said groove comprises randomly deleting at least one of said musical category loops and substituting at least one other loop from the same category in place of said deleted loop, and said deletion and substitution is repeated after playing each new loop for each of the remaining element categories of loops in said original groove composition.

15. Method of generation of musical composition grooves in a portable electronic music player device as in claim 12 wherein upon User selection to create a groove, said steps include:
c) selecting randomly a loop from said loop library of a first elements category, recalling and playing it repeatedly until accepted or not by said User;
ii) upon non-acceptance, selecting randomly a second loop from said elements category, recalling and playing it until accepted or not by said User;
d) upon acceptance of a given loop that is played, selecting randomly a loop from said loop library of a second loop elements category, overlaying it on said first loop and playing the combined multi-track loops repeatedly until accepted or not by said User; and
c) repeating the steps of selecting random loops, overlaying accepted loops and playing back of successive overlain loops in additional elements categories until a complete musical composition groove is produced,

16. Method of generation of musical composition grooves in a portable electronic music player device as in claim 11 which includes the added step of transferring a saved metadata file representing the loop elements of a groove to another device via at least one of writing to removable flash memory, transmitting said metadata file wirelessly, and connecting to said another device via by a connection between data ports in said two devices.

17. Method of generation of musical composition grooves in a portable electronic music player device as in claim 11 which includes the step of transferring at least one metadata file representing the loop elements of a groove to a website or another device via the Internet.

18. Method of generation of musical composition grooves in a portable electronic music player device as in claim 11 which includes the step of transferring to said device memory additional or replacement loop and groove libraries.

19. Method of generation of musical composition grooves in a portable electronic music player device as in claim 18 wherein said step of transferring includes the steps of initializing a browser, accessing an Internet site providing access to loop data files and groove metadata files, subscribing to said site in accord with the terms and conditions of said site, obtaining access to said files, selecting said files and downloading said files to said device.

20. Method of generation of musical composition grooves in a portable electronic music player device as in claim 19 wherein said step of subscribing to said Internet site includes paying a fee for at least one of the services of accessing and posting to bulletin boards, sharing of grooves created by Users, uploading and downloading of groove metadata files, and downloading of libraries of loop data files and groove metadata files

21. Method of saving a multi-element musical composition in digital memory for recall and playback as digital music files comprising the steps of:
a) extracting metadata from a multi-element musical composition representing a plurality of loops of individual musical elements, each of which is an element of said musical composition;
b) storing said musical composition as metadata in a digital memory file rather than as an audio file thereby vastly reducing the memory requirement for saved compositions and increaseing the digital memory storage efficiency;
c) recalling said metadata upon selection of said memory file;
d) reconstructing said musical composition by layering loops represented by said metadata to re-form said multi-element composition; and
e) playing said multi-element musical composition through speakers.

22. Method of saving a multi-element musical composition as in claim 21 wherein said metadata is stored in a first portable music player device, and said reconstructed multi-element musical composition is played back in a second music player device, and said method includes the added step of transferring said metadata from said first device to said second device.

23. Method of saving a multi-element musical composition as in claim 22 wherein said step of transferring includes transfer via the Internet to which said devices are connected.
